(19) United States
(12) Patent Application Publication
(10) Pub. No.: US 2006/0118194 A1
(43) Pub. Date: Jun. 8, 2006

(54) Cylindrical tube for a working cylinder, and method for producing the same

(76) Inventors: Wolfgang Mechler, Esslingen (DE); Klaus Voigt, Esslingen (DE); Bjorn Brandenburg, Denkendorf (DE); Adrian Hanimann, Schonengrund (CH); Rene Hug, Flawil (CH); Thierry Bauer, Herisau (CH)

Correspondence Address: Charles R Hoffmann;Hoffmann & Baron, 6900 Jericho Turnpike, Syosset, NY, 11791, US

(21) Appl. No.: 10/546,904

(22) PCT Filed: Mar. 12, 2004
(86) PCT No.: PCT/EP04/02570

§ 371 Date: Nov. 10, 2005

(30) Foreign Application Priority Data
Mar. 26, 2003 (DE) 103 13 477.8

(51) Int. Cl. F16L 11/00; B32B 37/00; B31F 5/04

(52) U.S. Cl. 138/125; 156/274.2; 156/379.7; 156/380.1

(57) ABSTRACT

A cylinder barrel for a fluid power cylinder comprising an inner tube (12) of thermoplastic synthetic resin and an outer tube (14) of fiber reinforced synthetic thermoplastic resin radially surrounding the inner tube (12) and being coaxially arranged, an intermediate layer (16) being placed between the inner tube (12) and the outer tube (14) to provide a firm join between the two tubes (12 and 14). There is a provision such that between the inner tube (12) and the outer tube (14) an intermediate layer (16) is arranged to ensure a firm join between the two tubes (12 and 14). The invention also relates to a method for the production of a cylinder barrel for a fluid power cylinder, in which in sequence an inner tube (12) of thermoplastic synthetic resin and a coaxially arranged outer tube (14) radially surrounding the inner tube and manufactured of fiber reinforced thermoplastic synthetic resin is extruded. An intermediate layer (16) is applied between the inner tube (12) and the outer tube (14) to provide a firm connection between the two tubes (12 and 14).

The invention relates to a cylinder barrel for a fluid power cylinder and more particularly for a pneumatic cylinder and furthermore to a method for the manufacture of the cylinder barrel.

A cylinder for a piston and cylinder unit is described in the European patent publication 0 384 948 B1. The cylinder possesses a tubular cylinder housing manufactured of synthetic resin and in which a cylinder bore opening is molded to receive a piston for sliding motion therein. Its wall connected with at least one stiffening element provided in the peripheral part of the bore opening and outside it, such element being in the form of a stiffening rod or bar. The stiffening element extends in parallelism to the longitudinal direction of the bore opening along same and is retained in a recess in the wall of the cylinder housing.

Furthermore the German patent publication 4,107,375 C2 describes a cylinder barrel for a fluid power cylinder. The cylinder barrel comprises a tubular stiffening part that possesses several radial openings through it and which is embedded between a tubular inner synthetic resin part and a tubular outer synthetic resin part. The two synthetic resin parts are joined together in an interlocking manner by means of connecting projections extending through the opening.

Finally the European patent publication 0 572 774 B1 discloses a housing for a fluid power cylinder that has a cylinder barrel comprising an inner tube and a coaxially arranged outer tube firmly surrounding, and in direct contact with it, the inner tube radially to the outside. The inner tube is a metal tube. The outer tube is a synthetic resin tube that consists of non-reinforced synthetic resin material.

As regards prior art furthermore the German patent publication 4,107,375 C2, the European patent publication 0 572 774 B1, the European patent publication 0 384 948 B1, the Japanese patent publication 63-176874 (abstract), the U.S. Pat. No. 4,207,807 and the U.S. Pat. No. 3,802,985 are to be mentioned.

The object of the present invention is to provide a cylinder barrel for a fluid power cylinder that while having a high degree of stiffness and a low weight possesses satisfactory running properties.

To achieve this aim the invention provides a cylinder barrel for a fluid power cylinder comprising an inner tube of thermoplastic synthetic resin and a coaxially arranged outer tube surrounding the inner tube to the outside thereof, said outer tube consisting of fiber reinforced thermoplastic synthetic resin, an intermediate layer being provided between the inner tube and the outer tube to provide a firm join between the two tubes with each other.

The invention provides a cylinder barrel for a fluid power cylinder which possesses an inner tube consisting of thermoplastic synthetic resin and a coaxially arranged outer tube (manufactured of fiber reinforced synthetic resin) surrounding the inner tube radially to the outside. In accordance with the invention an intermediate layer is arranged between the inner tube and the outer tube to ensure a firm connection between the two tubes.

In accordance with a first embodiment of the invention the intermediate layer consists of hot melt adhesive connecting the two tubes firmly together. Owing to this intermediate layer relative movement of the two tubes is prevented.

An alternative design of the invention provides for the intermediate layer to consist of an electrically conductive layer by means of which an alternating magnetic field may be produced. Preferably the electrically conductive intermediate layer consists of separate individual conductors, of a braid or fabric of conductors, which when subjected to AC are able to cause heating of their immediate surroundings owing to the formation of an alternating magnetic field. By heating to a suitable temperature joining by fusion of the thermoplastic inner tube to the outer tube also consisting of synthetic resin is possible. This leads to an intimate and firmly adhering join of the two tube applied to each other.

The inner tube and the outer tube may consist of the most various synthetic resin materials. The inner tube mostly serves to guide a piston and to ensure a fluid-tight and wear resistant running layer on which a piston driven by fluid as a pressure medium may slide with minimum friction. If in addition the material of the inner tube is to have a certain degree of inherent flexibility in order when subjected to high working pressures to achieve a satisfactory sealing action at the piston surface. Furthermore the inner layer must be evenly round and have a high quality to its surface and furthermore be able to meet substantial requirements as regards its anti-friction or running properties. The material of the inner tube must possess a maximum resistance to wear. However, the synthetic resin of the inner tube can not be provided with fiber reinforcement, since the fiber ends would lead to an increased wear of a drive piston sliding in the inner tube and more particularly the seals thereof. Accordingly non-reinforced synthetic resin is employed for the inner tube and more especially a tough thermoplastic material having an extremely smooth surface.

On the other hand the outer tube has to ensure external robustness and primarily serves to endow the entire cylinder barrel with a sufficiently high degree of strength while minimizing deformation by the operating pressure and owing to external effects. Furthermore the outer tube serves to provide the cylinder barrel with a high and permanent resistance to external environmental effects. If appropriate it is possible for this purpose to provide a further protective layer on the outer tube, as for example in the form of a paint layer, fused powder coating or the like.

Preferably the thickness of the intermediate layer is in any case smaller than the wall thickness of the inner tube and of the outer tube. The maximum thickness of the intermediate layer may more especially be approximately 0.15 mm, but preferably however smaller than 0.1 mm. It is convenient for the wall thickness of the fiber reinforced outer tube to be larger than that of the inner tube, since the outer tube is responsible for the mechanical strength. Typically the wall thickness of the inner tube will be 3 to 8% of its inner diameter. A typical wall thickness of the outer tube can be approximately 6 to 15% of the inner diameter of the inner tube. The thickness of the intermediate layer may accordingly be equal to approximately 0.1 to 0.5% of the inner diameter of the inner tube. For instance the inner diameter of the inner tube may be 25 mm and typical layer thicknesses of the inner tube may be 1 mm, of the intermediate layer 0.05 mm and of the outer tube 2 mm.

The outer tube may in accordance with one embodiment of the invention consist of fiber reinforced polyoxymethylene (POM) or of polyamide. For the fiber reinforcement more particularly glass fibers or carbon fibers are suitable at a fiber fraction of between approximately 20 and 50%. The fiber fraction is preferably equal to around 30%. The use of glass fibers renders possible extremely economic manufacture of the cylinder barrel. Carbon fiber has a substantially higher strength and accordingly renders possible reduced wall thicknesses for the outer tube, while however increasing the costs of production owing to its substantially higher price as such.

The inner tube may in accordance with one working example of the invention consist more especially of a layer of non-reinforced acrylonitrile-styrene ester-acryl ester (ASA). This material possesses particularly satisfactory low friction properties and possesses the necessary flexibility while also being sufficiently tough.

A further aim of the present invention resides in creating a method for the production of low-price and high-strength cylinder barrels in which a power piston may run.

This further object of the invention is attained by a method for the production of a cylinder barrel for an fluid power cylinder in the case of which in sequence an inner tube of thermoplastic synthetic resin and an outer tube, of fiber reinforced thermoplastic synthetic resin, coaxially surrounding it radially to the outside is extruded, an intermediate layer being present between the inner tube and the outer tube to provide a firm join between the two tubes.

Accordingly a method for the manufacture of a cylinder barrel for fluid power cylinder contemplates the following method steps. Using an extrusion method an inner tube of thermoplastic synthetic resin is produced. On this inner tube an intermediate layer is applied, preferably following a cooling phase for the inner tube. Then in a further extrusion step an outer tube is applied to the intermediate layer, such outer tube surrounding the inner tube and the intermediate layer radially to the outside thereof and being coaxially arranged in relation to the inner layers. The outer tube and the inner tube are firmly joined together with the aid of the intermediate layer. This means that any relative movements will be prevented owing to the different materials and any insufficient adhesion in connection with it.

A first version of the method in accordance with the invention provides for the application between the inner tube and the outer tube of an intermediate layer connecting the two tubes firmly together and consisting of hot melt adhesive. Prior to the application of this adhesive layer cooling down of the inner tube is preferably awaited so that same will have reached its final dimensional stability and does not undergo deformation and/or compression in the following extrusion steps. The outer tube may be directly applied, after the application of the hot melt adhesive, to such applied layer and endows the cylinder barrel with its final dimensional stability and strength.

In accordance with an alternative form of the method of the invention the inner tube is, after its production, wound up in an intermediate layer of electrically conductive material, onto which then using an extrusion method the outer tube of fiber reinforced thermoplastic synthetic resin is produced. The electrically conductive intermediate layer may, after the application of the outer tube, be subjected to an electric current so that an alternating magnetic field is produced in the boundary layer between the inner tube and the outer tube. This means that there is a heating effect and with suitable control the thermoplastic synthetic resin is fused and after cooling down there is a strong and intimate join between the inner tube and the outer tube.

Further aspects and advantages of the invention will be seen from the dependent claims and the following description of working examples.

In the following preferred examples will be described with reference to the accompanying drawings in more detail.

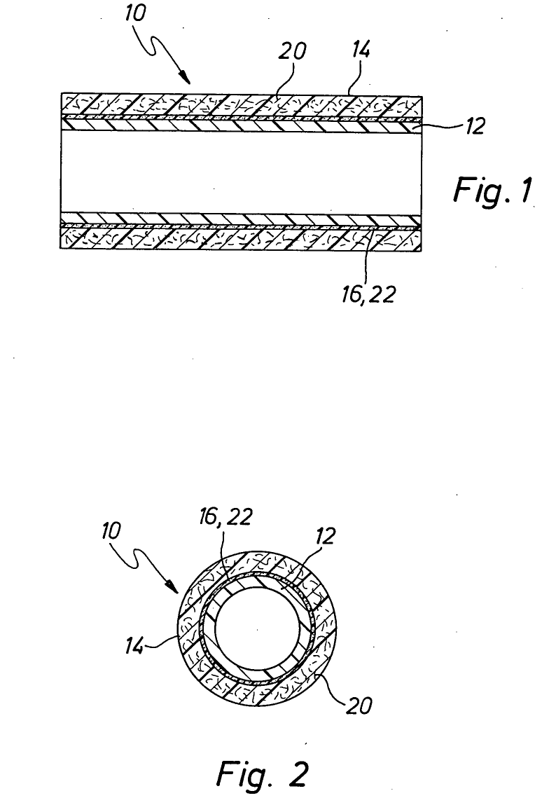

FIG. 1 shows a cylinder barrel in accordance with the invention in a diagrammatic longitudinal sectional representation.

FIG. 2 shows the cylinder barrel in accordance with FIG. 1 in a diagrammatic cross sectional representation.

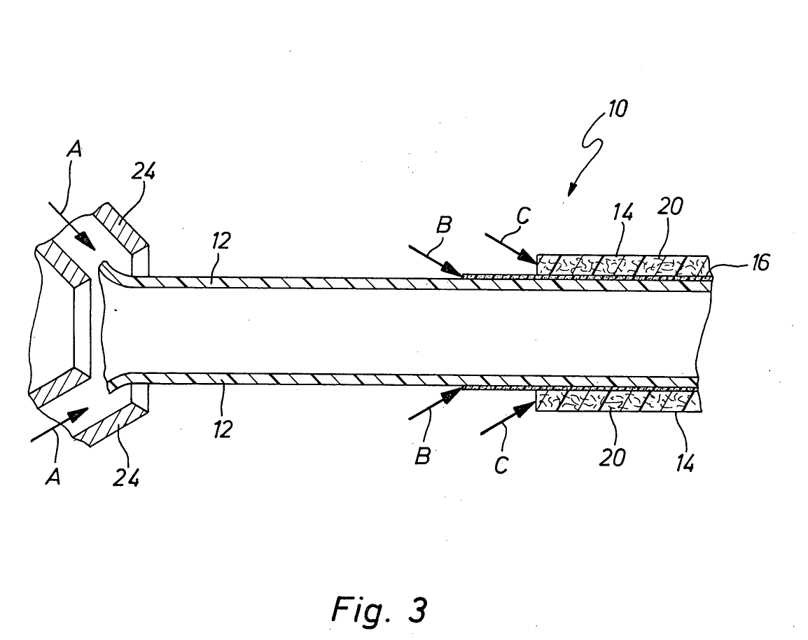

FIG. 3 shows a diagrammatic longitudinal sectional representation of consecutive method steps for the production of the cylinder barrel in accordance with FIG. 1.

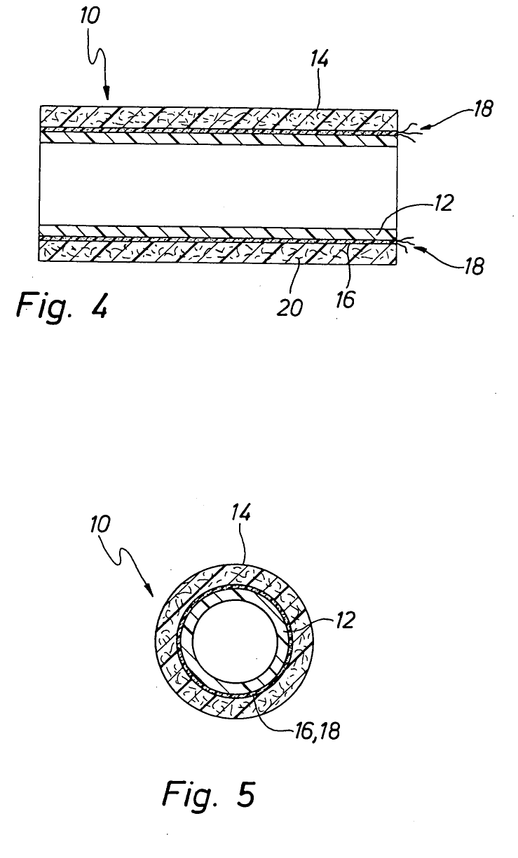

FIG. 4 shows an alternative design of the cylinder barrel in a diagrammatic longitudinal sectional showing.

FIG. 5 represents the cylinder barrel of FIG. 4 in a diagrammatic cross sectional representation.

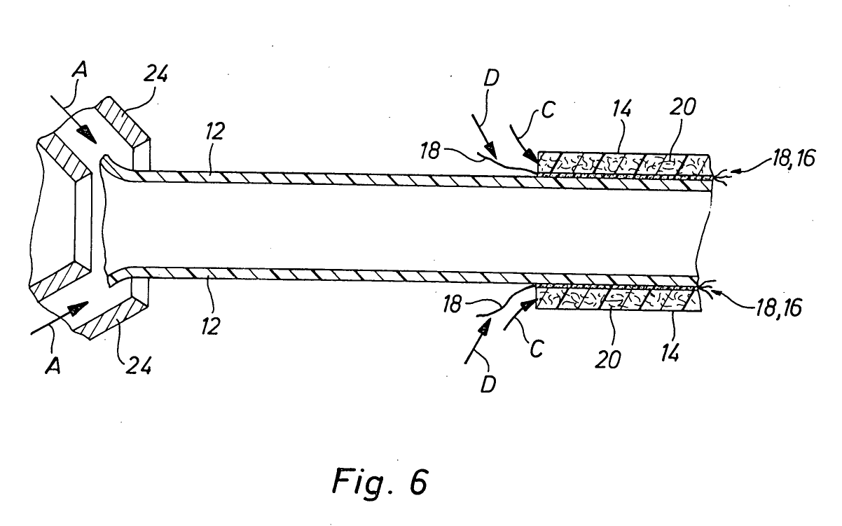

FIG. 6 shows a further diagrammatic longitudinal sectional representation of consecutive method steps for the manufacture of the cylinder barrel in accordance with FIG. 4.

A first design of the cylinder barrel 10 in accordance with the invention is indicated with reference to FIGS. 1 and 2. The cylinder barrel 10 is, in the illustrated working example, made up of three coaxially arranged layers. An inner tube 12 serves for a working piston (not illustrated) to run in, which is able to be subjected to pressure and may implement linear thrust movements. The inner tube 12 consists of a thermoplastic synthetic resin which preferably is free of fiber reinforcement. An also cylindrical outer tube 14 is arranged around such cylindrical inner tube 12, the outer tube 14 also consisting of thermoplastic synthetic resin. The outer tube 14 however possesses fiber reinforcement 20 to enhance its strength. Between the inner tube 12 and the outer tube 14 there is an intermediate layer 16 connecting the two tubes together, and consisting, in the illustrated working example, of a hot melt adhesive 22.

FIG. 3 indicates the method for the manufacture of the cylinder barrel 10 that preferably is produced in a multi-stage extrusion method. In a first method step the inner tube 12 of thermoplastic synthetic resin is extruded. In the diagrammatic representation of FIG. 3 this method step is only indicated by showing the extrusion of the inner tube through an extrusion head. This method step is indicated by the two arrows A.

As a material for the inner tube 12 basically any thermoplastic synthetic resin may be employed which provides the desired strength and low-friction properties and furthermore possesses a sufficient resistance to wear during a long service life. More particularly a acrylonitrile-styrene ester-acryl ester (ASA) is well suited, which preferably does not have any fiber reinforcement. The outer tube may more especially consist of polyamide, polyoxymethylene (POM) or of other suitable high-strength thermoplastic synthetic resins.

After the inner tube 12 has cooled down in a further extrusion step the intermediate layer 16 may be applied in the form of the hot melt adhesive 22, something which is indicated by the two arrows B. Directly following this in a further extrusion step the outer tube 14 of fiber reinforced synthetic resin is applied, something which is indicated by the two arrows C.

The inner tube 12 serves for exact guidance and sealing of the power or working piston. It can be therefore made relatively thin. One known method for increasing the strength of synthetic resins and for reducing the necessary wall thickness lies in the use of so-called filled materials, which are more particularly provided with fiber reinforcement. The inner tube 12 however in the present case can not be provided with fiber reinforcement, since the fiber possibly might impair the running properties of the inner peripheral face, functioning as a bearing surface, and this would damage seals of the drive piston sliding on it. This would lead to a much reduced working life of the fluid power cylinder. Accordingly a stabilizing outer tube 14 is arranged around the inner tube 14 that is firmly connected with the same by means of the intermediate layer 16 and prevents relative movement of the two tubes.

The outer tube 14 serves to mechanically stabilize the cylinder barrel and is therefore preferably designed with a substantially greater wall thickness. As a fiber reinforcement 20 in the outer tube 14 more particularly glass fibers and/or carbon fibers are suitable dependent what strength properties are required or what manufacturing costs can be tolerated. The fiber fraction may be typically approximately 30%. The intermediate layer 16 may on the other hand be extremely thin. Typical wall thicknesses applying for an inner diameter of the inner tube 12 of approximately 25 mm will be approximately 1 mm for the inner tube with approximately 0.05 mm for the intermediate layer 16 of hot melt adhesive 22 and approximately 2 mm for the outer tube 14.

Using the method described herein it is possible for substantial lengths of cylinder barrel 10 with high dimensional accuracy and extremely even wall thicknesses to be manufactured. Accordingly cylinder barrel 10 lengths of over 3000 mm may be produced that dependent on the specification and selection of material will have a service life of over 20 million load cycles without involving any problems.

FIGS. 4 and 5 show an alternative design of the cylinder barrel 10 in accordance with the invention, whose intermediate layer 16 does not consist of hot melt adhesive but of an electrically conductive layer. This electrically conductive intermediate layer 16 may for example be constituted by thin conductors 18 wound around the inner tube 12. The intermediate layer 16 may also be in the form of a braid or fabric of conductors 18.

FIG. 6 indicates the production of such a cylinder barrel 10 in the case of which initially the inner tube 12 is extruded using non-reinforced thermoplastic synthetic resin. This first method step is indicated by the two arrows A, viscous synthetic resin being forced through the extrusion head 24 and forming the inner tube 12 after solidification. The electrically conductive intermediate layer 16 is then applied around same, for example by winding individual conductors 18, a fabric or a braid of conductors 18. Such application or winding is indicated by arrows D. Then the outer tube 14 is applied by extrusion, see arrows C.

The electrically conductive intermediate layer 16 serves to subsequently increase the mechanical adhesion, which sometimes may be unsatisfactory, between the inner tube and the outer tube. This increase may be ensured by using the intermediate layer 16 as a secondary coil producing an alternating magnetic field. The eddy currents produce a heating effect and an increased temperature above the fusing temperature of the inner and outer tubes. Accordingly the two tubes are welded together, this increasing the strength characteristics and accordingly a reduction of the necessary wall thickness.

The materials, wall thicknesses and dimensions of the second design in accordance with FIGS. 4 through 6 may moreover be the same as in the first design of FIGS. 1 through 3.

1. A cylinder barrel for a fluid power cylinder, comprising an inner tube of thermoplastic synthetic resin and an outer tube of fiber reinforced synthetic thermoplastic resin radially surrounding the inner tube and being coaxially arranged, an intermediate layer being placed between the inner tube and the outer tube to provide a firm connection between the two tubes.

2. The cylinder barrel as set forth in claim 1, wherein the intermediate layer consists of a hot melt adhesive layer firmly connecting the two tubes together.

3. The cylinder barrel as set forth in claim 1, wherein the intermediate layer consists of an electrically conductive layer for producing an alternating magnetic field.

4. The cylinder barrel as set forth in claim 3, wherein the electrically conductive intermediate layer comprises separate conductors, a braid or a fabric.

5. The cylinder barrel as set forth in claim 3, wherein the electrically conductive intermediate layer is adapted to be heated by the action of an electric current.

6. The cylinder barrel as set forth in claim 3, wherein the inner tube is able to be fusion bonded to the outer tube by heating the electrically conductive intermediate layer.

7. The cylinder barrel as set forth in claim 1, wherein the inner tube and the outer tube consist of different thermoplastic synthetic resin materials.

8. The cylinder barrel as set forth in claim 1, wherein the intermediate layer has a thickness respectively smaller than that of the wall of the inner tube and of the outer tube.

9. The cylinder barrel as set forth in claim 8, wherein the thickness of the intermediate layer is at the most approximately 0.15 mm.

10. The cylinder barrel as set forth in claim 1, wherein the outer tube possesses a greater wall thickness than the inner tube.

11. The cylinder barrel as set forth in claim 1, wherein the wall thickness of the inner tube is approximately 3 to 8% of its inner diameter.

12. The cylinder barrel as set forth in claim 1, wherein the wall thickness of the outer tube is approximately 6 to 15% of the inner diameter of the inner tube.

13. The cylinder barrel as set forth in claim 1, wherein the thickness of the intermediate layer is approximately 0.1 to 0.5% of the inner diameter of the inner tube.

14. The cylinder barrel as set forth in claim 1, wherein the outer tube consists of fiber reinforced polyoxymethylene (POM) or of polyamide (PA).

15. The cylinder barrel as set forth in claim 1, wherein the outer tube possesses a fiber reinforcement of glass and/or carbon fibers.

16. The cylinder barrel as set forth in claim 1, wherein the fiber fraction of the outer tube is approximately 20 to 50%.

17. The cylinder barrel as set forth in claim 1, wherein the inner tube comprises non-reinforced acrylonitrile-styrene ester-acryl ester (ASA).

18. A method for the manufacture of a cylinder barrel for a fluid power cylinder, wherein in sequence an inner tube of thermoplastic synthetic resin and a coaxially arranged outer tube radially surrounding the inner tube and manufactured of fiber reinforced thermoplastic synthetic resin is extruded, an intermediate layer being applied between the inner tube and the outer tube to provide a firm connection between the two tubes.

19. The method as set forth in claim 18, wherein, between the inner tube and the outer tube, a hot melt adhesive layer is applied for firmly connecting the two tubes together.

20. The method as set forth in claim 19, wherein the intermediate layer of hot melt adhesive is applied after a cool down phase on the inner tube.

21. The method as set forth in claim 19, wherein the outer tube is applied by extrusion onto the intermediate layer directly following the application of the intermediate layer of hot melt adhesive.

22. The method as set forth in claim 18, wherein the inner tube after its production becomes an intermediate layer of electrically conductive material wound on it on which then the outer tube is applied by extrusion.

23. The method as set forth in claim 22, wherein the electrically conductive intermediate layer is subjected to an electric current after the application of the outer tube.

24. The method as set forth in claim 23, wherein the outer and inner peripheral faces, in contact with each other, of the inner tube and the outer tube are firmly fusion-bonded together by heating of the electrically conductive intermediate layer.
